(19) United States
(12) Patent Application Publication
(10) Pub. No.: US 2002/0146481 A1
(43) Pub. Date: Oct. 10, 2002

(54) Process for the production of hollow plastic articles

(76) Inventor: Andreas Wust, Zwingenberg (DE)

Correspondence Address: CONNOLLY BOVE LODGE & HUTZ LLP, 1220 MARKET STREET, P.O. Box 2207, WILMINGTON, DE, 19899, US

(21) Appl. No.: 10/026,007

(22) Filed: Dec. 21, 2001

(30) Foreign Application Priority Data
Dec. 22, 2000 (DE) 100 64 801.0

(51) Int. Cl. B29C 49/22; B29C 49/48; B29C 65/48; B29C 65/78

(52) U.S. Cl. 425/522; 249/52; 156/264; 156/244.14

(57) ABSTRACT

The present invention relates to a process for the production of hollow plastic articles, said process comprising the following steps:

a) molding a blow mold article in a blow molding and/or co-extrusion blow molding machine, whereby the blow molding cavity formed by the two sold contours is shaped in such a way that said cavity essentially matches the outer contour of the plastic hollow article to be fabricated and, in addition, it has a circumferential indentation and/or protuberance, preferably located in the middle relative to the nip-off edge;

b) separation of the indentation and/or protuberance, which yields at least two sheets;

c) optionally, prior to joining the sheets together to form a hollow article, installation of the built-in components on the inside of the sheets;

d) joining the sheets together to form a hollow article, optionally by means of welding or gluing.

### DESCRIPTION

The present invention relates to a process for the production of hollow plastic articles in a blow molding machine or co-extrusion blow molding machine. Moreover, the present invention relates to hollow plastic articles that can be produced by means of the above-mentioned process and it also relates to their use, for example, as fuel tanks in motor vehicles.

Hollow plastic articles have long been known as a means to store and transport hazardous liquids. Particularly in automotive construction, hollow plastic articles in the form of fuel tanks have almost completely replaced the tanks made of metal materials that were used in the past. But all kinds of portable or non-stationary containers such as, for instances, jerry cans, plastic bottles, plastic drums and plastic tanks for flammable liquids, hazardous materials and the like are also made almost exclusively of plastic nowadays. The special advantage of plastic containers and tanks is, first and foremost, their low weight-to-volume ratio and the avoidance of corrosion problems as well as their inexpensive fabrication.

Various processes can be employed in the production of hollow plastic articles. In addition to so-called rotational sintering, particularly blow molding, including co-extrusion blow molding, are employed on a large scale in mass production.

Due to the worldwide statutory regulations requiring the reduction of ozone-forming emissions such as, for example, fuel emissions, all plastic fuel tanks used in vehicles must ensure that no fuel can escape when the vehicle is either running or parked. To the extent that the plastic employed in the manufacture of a plastic fuel tank does not have inherent barrier properties, additional measures have to be adopted to reduce permeation.

The polyolefins often used in the manufacture of plastic fuel tanks exhibit only a low barrier effect against the permeation of highly volatile, non-polar substances. The barrier properties of plastic fuel tanks made, for instance, of polyethylene can be substantially improved by means of, among other things, fluorination (in-line or off-line), painting or coating, plasma polymerization, blends (Selar® method) or co-extrusion (incorporation of various barrier polymers into a multilayer composite).

Aside from the co-extrusion blow molding process, only fluorination and the Selar® method have attained technical significance as barrier methods. The fluorination methods known in the state of the art are coating processes in the broadest sense. A fundamental disadvantage shared by all coating processes is that the barrier layer or layers necessarily have to be applied onto the inner and/or outer surface of the container, and so they are exposed without protection to the effects of the environment. Consequently, over the course of time, the barrier layer can peel off or undergo a chemical change, as a result of which the barrier properties are significantly impaired. In view of the strict legal stipulations pertaining to the long-term stability of the barrier effect, coating processes, such as fluorination, will continue to lose significance in the coming years. This development is also being intensified by the fact that, in order to meet the statutory requirements regarding the avoidance of fuel emissions from the fuel system, it is more often the case that components need to be integrated into the interior of the tank. Such built-in components can only be installed prior to the coating process if they cannot become damaged during the coating process. If the coating is carried out prior to the installation of some of the components, it must be assumed that the coating will be damaged at the places of attachment (welding points) in the tank.

Due to the above-mentioned reasons, today's developments are concentrated on the production and structuring of multilayer systems. For instance, the multilayer co-extrusion method is employed in order to incorporate barrier layers into the tank wall. Here, bonding agents are used to embed barrier polymers into a polymer carrier matrix. Normally, the barrier polymer is located in the middle of the tank wall, as a result of which, on the one hand, the flexural stresses that occur due to mechanical load can be minimized in the usually more brittle barrier polymers while, on the other band, the barrier polymer is protected against environmental influences—particularly water—by the matrix material such as, for example, polyethylene.

One of the methods employed to create multilayer hollow articles is the above-mentioned co-extrusion blow molding. Blow molding or co-extrusion blow molding is a widespread technique which, however, has the drawback that components. Such as those of the fuel system, cannot be integrated after the fabrication of the plastic hollow article, or else this entails great difficulty.

In another manufacturing method known in the state of the art—the so-called thermoforming process or twin-sheet process—two half shells are first made by deep-drawing the appropriate sheets and then welding them together in a second process stop. A fundamental disadvantage of this method, among other things, however, is that there is only limited control over the wall thickness distribution in the tank half shells. The wall thickness distribution and thus the barrier-layer distribution cannot be sufficiently controlled so that, depending on the stretching conditions during deep-drawing, the wall thickness or the thickness of the barrier layer can be very diminished at certain places.

Another method used to manufacture multilayer hollow plastic articles is based on the injection molding process known in the state of the art. A considerable drawback of this method is the fact that, in order to create multilayered shells, either thick-walled, multilayered sheets prepared in a separate process have to be back-injected or else thinner sheets, which likewise have to be prepared separately, are back-injected on both sides in two consecutive steps. Consequently, in either case, several process steps ate fundamentally needed, which involves quite complex equipment, as a result of which a high investment of time and money is required for the production of multilayer hollow plastic articles.

DE 198 14 314 describes a so-called melt-press molding method in which a co-extruded parison, for example, a tube made on a blow molding machine, is inserted into a mold and pressed with a stamp or negative die to form a half shell. The drawback here is that, during the press molding procedure, a pronounced melt nip-off flow occurs parallel to the mold surface, as a consequence of which, even though the overall wall thickness can be determined quite well on the basis of the geometrical dimensions of the die and of the stamp, the usually low-viscosity melt of the barrier polymer is thinned out in places. This, in turn, gives rise to a barrier effect that is unevenly distributed over the hollow plastic article.

The statements above show that the methods known in the state of the art for the production of hollow plastic articles entail a number of serious drawbacks. Therefore, there is a great need to create a process for the production of hollow plastic articles which is capable of avoiding the above-mentioned disadvantages of the state of the art. The present invention was also based on the objective of developing an improved method with which the already existent blow molding or co-extrusion blow molding machines that are widespread in the industry can continue to be utilized.

Other objectives ensue from the description of the invention below.

The achievement according to the invention of the process-related objectives is based on the features of Claim 1.

Advantageous embodiments of the process according to the invention are disclosed in the subordinate claims of the process.

According to the invention, a process is created for the production of hollow plastic articles, said process comprising the following steps:

a) molding a blow molded article in a blow molding and/or co-extrusion blow molding machine, whereby the blow molding cavity formed by the two mold contours is shaped in such a way that said cavity essentially matches the outer contour of the plastic hollow article to be fabricated and, in addition, it has a circumferential indentation and/or protuberance, preferably located in the middle relative to the nip-off edge:

b) separation of the indentation and/or protuberance, which yields at least two sheets;

c) optionally, prior to joining the sheets together to form a hollow article, installation of the built-in components on the inside of the sheets;

d) joining the sheets together to form a hollow article, optionally by means of welding or gluing.

It was found that the process according to the invention for the production of hollow plastic articles avoids the disadvantages entailed by the methods known in the state of the art.

The principle of the process according to the invention for the production of plastic hollow articles consists first of the conventional fabrication of a blow molded article in a regular blow molding or co-extrusion blow molding machine. It is provided according to the invention that the cavity formed by the two mold contours is shaped in such a way that said cavity essentially matches the outer contour of the plastic hollow article or plastic tank to be manufactured. It is essential to the invention for the above-mentioned blow molding cavity or the blowing mold used for the process according to the invention to additionally have a circumferential indentation and/or protuberance, preferably located in the middle relative to the nip-off edge. “Circumferential” as defined according to the present invention means that the indentation and/or protuberance preferably extends around the entire blow molded article or plastic hollow article. Therefore, the modified configuration of the contact areas of the mold, which is new in comparison to the commonly employed blowing molds, allows the creation of a hollow plastic article that has an indentation and/or protuberance (a groove or bead) extending around the container.

In the second step of the process according to the invention, the described indentation and/or protuberance is separated, preferably in the perpendicular direction with respect to the above-mentioned indentation and/or protuberance. Two half shells or sheets are obtained by this separation procedure, that is to say, for instance, by cutting, grinding or punching out the indentation and/or protuberance that encircles the hollow plastic article. In the last step of the process according to the invention, the half shells thus obtained are glued and/or welded together to form a hollow article.

Another subject matter of the present invention is a hollow plastic article that can be manufactured by means of the process described above. According to the invention, it is provided that the hollow plastic articles manufactured by means of the process according to the invention are preferably employed as plastic fuel tanks in automobiles, but also as jerry cans, plastic tanks for storing and transporting heating oil, diesel and solvents, transportation containers on commercial vehicles such as, for instance, for agricultural spraying agents, solvent containers, plastic bottles and the like.

Another subject matter of the present invention is a blowing mold designed according to the invention and used to carry out the process described here. This newly designed blowing mold has a blow molding cavity formed by the two mold contours in such a way that said cavity essentially matches the outer contour of the plastic hollow article to be manufactured and, in addition, it has a circumferential indentation and/or protuberance, preferably located in the middle relative to the nip-off edge.

A major advantage of the process according to the invention lies in the use of a modified blowing mold. The design according to the invention of the blow molding cavity is selected in such a way that, in the area of the mold parting surface or of the nip-off edge, the blow molded article thus fabricated has additional geometrical areas in the form of an indentation and/or protuberance extending all around the plastic container. The indentation and/or protuberance or the geometrical areas are shaped in such a way that, after the actual blow molding process, the blow molded article can be separated into two or more parts, for example, a top part and a bottom part of an automobile fuel tank. According to the invention, it is especially preferred if the indentation and/or protuberance is designed in such a way that, after the separation, the at least two sheets or half shells have surfaces that are parallel to each other, which allows a very simple and reliable joining of the sheets. In a particularly preferred embodiment, the indentation and/or protuberance has an essentially rectangular or U-shaped cross section.

It is likewise provided according to the invention that the appropriate built-in components are installed in or on the obtained half shells before they are joined together. In a preferred embodiment the joining surfaces resulting from the specific modification of the mold are welded or glued together.

Another advantage of the production process according to the present invention lies in the fact that, before the sheets are joined together, optionally, inserts—such as components of a fuel system—can be easily installed on the inside of the half shells. Therefore, according to the invention, it is provided that built-in components such as, for instance, ventilation lines for pressure equalization inside the tan fuel lines for liquid equalization inside the tank, valves, surge chambers, pump modules and/or tank modules, can all be installed on the inside before the thermoformed sheets are welded together.

The sheets are preferably welded together using the process heat, that is to say, the sheets, which are melt-hot following the blow molding procedure are immediately welded together.

With the process according to the invention, the two sheets advantageously do not cool down completely prior to being welded together.

Another considerable, advantage of the process according to the invention is that it allows a precise control of the wall thickness of the plastic parison in the blow molding or co-extrusion blow molding machine used. The precise regulation of the wall thickness of the plastic parison accounts for a significant improvement of the wall thickness control during the subsequent blow molding process. The diameter or the circumference of the plastic parison is defined by the diameter of the extrusion parison die and should be adapted to the requirements of the process steps that follow. The wall thickness of the plastic parison can be regulated in the axial direction during the extrusion by means of the variable die gap. When profiled die-mandrel pairs or flexible die rings are used that can be deformed with the suitable control elements (partial wall thickness control), it is also possible to achieve radial wall thickness control.

Advantageously, existing co-extrusion blow molding machines can be employed for the process according to the invention. All that would be necessary is for the blow molding machines to be equipped with the appertaining blowing molds designed according to the invention.

In a preferred embodiment according to the invention, it is provided that robots are employed to perform individual work stops of the process, especially to separate the blow molded article and to join the resulting sheets together.

Due to the high stress on the plastic material and to the high requirements made, for instance, with respect to the barrier effect, the hollow plastic articles fabricated by the process according to the invention are preferably made up of several layers.

Preferably, the hollow plastic articles according to the invention are made up of at least two layers. These layers always include a load-bearing base layer that normally constitutes the inner surface of the hollow article. Therefore, this layer is of crucial importance for the tightness and mechanical stability of the container.

In a special embodiment, the blow molded article produced has at least one layer consisting of polymeric material, preferably selected from among the group comprising polyethylene, polypropylene, polyvinyl chloride, polyamide, polyketone, polyester and/or mixtures thereof.

In another preferred embodiment, the blow molded article is made up of several layers, preferably containing at least one base layer, millbase layer, bonding agent layer and/or barrier layer.

The layer thickness distribution within the finished article depends on the number of layers. The layer thickness distribution in a plastic blow molded article manufactured by means of the process according to the invention, which consists of six layers, is described below. In a particularly preferred embodiment, a plastic blow molded article or a plastic hollow article is produced that is made up of six layers comprising the following from the outside to the inside:

a layer consisting of HDPE having a thickness ranging from 5% to 30%,

a millbase layer having a thickness ranging from 10% to 82%.

a bonding agent layer having a thickness ranging from 1% to 50%,

a barrier layer having a thickness ranging from 1% to 10%,

a bonding agent layer having a thickness ranging from 1% to 5%,

a layer consisting of HDPE having a thickness ranging from 10% to 40%,

each relative to the total thickness of the container wall.

Suitable base materials include high-density polyethylene (HDPE) having a thickness ranging from 0.940 g/cm³ to 0.960 g/cm³, particularly from 0.943 g/cm³ to 0.955 g/cm³ and especially preferred from 0.943 g/cm³ to 0.950 g/cm³. The melt flow rate (MFR) of the polyethylene materials that are suitable according to the invention lies between 1.5 and 20 g/10 min (MFR at 190° C. [374° F.]/21.6 kg), particularly between 2 and 10 g/10 min and especially preferred between 3 and 8 g/10 min. Natually, other polymeric materials mentioned before are also suitable as the load-bearing base material

Suitable barrier material include ethylene vinyl alcohol copolymers (EVOH), polyamide or also other barrier polymers such as polyester, especially polybutylene terephthalate, fluoropolymers such as polyvinylidene fluoride, ethylene-tetra-fluoroethylene copolymer (ETFE), tetrafluoroethylene hexafluoropropylene vinylidene fluoride copolymer (THV) as well as liquid-crystalline polymers (LCP).

Likewise suitable are mixtures of the above-mentioned barrier materials having so-called nanoparticles. Nanoparticles according to the present invention are organic layer silicates whose atomic layers have been expanded and thus loosened up by the inclusion of organic molecules. The incorporation into polymeric materials allows the atomic layers to be separated, as a result of which an extremely fine distribution of the particles is achieved. The surface area of the dispersed particles translates into an extreme lengthening of the diffusion path of an optionally permeating molecule, thus reducing the permeation.

Bonding agents suitable according to the invention comprise polar-modified polyethylene (HDPE or LLDPE and LDPE). The polar-modification is normally carried out by means of graft copolymerization with polar molecules having C═C double bonds such as, for instance, fumaric acid, maleic acid or else maleic acid anhydride. The grafted polyethylenes can be additionally chemically modified in subsequent reactions, for example, by incorporating amino groups. Moreover, copolymers of ethylene with vinyl acetate, acrylic acid or their esters are also fundamentally suitable as bonding agents.

The so-called millbase layer is preferably made of so-called parison waste which is generated as residual material or as production waste, for example, in the manufacture of the hollow plastic articles.

In another preferred embodiment, it is proposed according to the invention that the hollow plastic articles are provided with an additional permeation-reducing coating after the two sheets have been welded together. The permeation-reducing coating can be obtained, for instance, by means of the direct fluorination, painting or plasma polymerization of the plastic container.

It is advantageous to carry out the production process according to the invention in different (geographical) locations. For example, the blow molded article to be manufactured in the first step can be made in a conventional blow molding plant. Preferably, the blow molded articles obtained are separated according to the second process step so that they can be subsequently transported to the final fabrication site, where the sheets or half shells thus obtained are completed and joined together or assembled. The process steps according to the invention allow a very space-saving transportation of the sheets or half shells in an advantageous manner since they can easily be stacked together, thus saving expensive loading volume. With the processes known according to the state of the art, normally closed containers that take up a large volume are obtained, something which is obviously disadvantageous for the transportation.

### DESCRIPTION OF THE FIGURES

FIG. 1 schematically shows the blowing mold according to the invention.

FIG. 2 is a schematic representation of the process sequence according to the invention.

FIG. 3 schematically shows designs of the protuberance according to the invention (top view).

FIG. 4 schematically shows designs of the protuberance according to the invention (cross section).

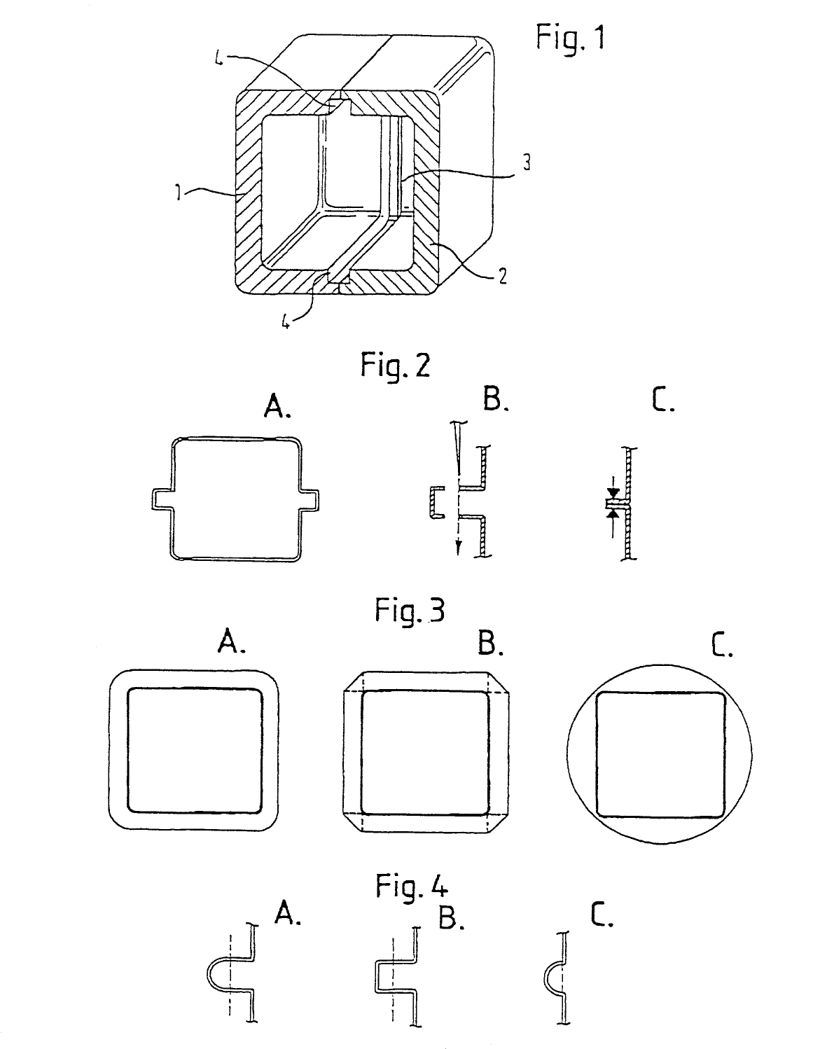

According to FIG. 1, the blow molding cavity (3) formed by the two mold contours (1) and (2) of the blowing mold according to the invention is shaped in such a way that said cavity essentially matches the outer contour of the plastic hollow article to be manufactured and, in addition, it has a circumferential indentation and/or protuberance, preferably (4) located in the middle relative to the nip-off edge.

FIG. 2 shows the schematic process sequence, which comprises steps A) blow molding, B) separation and C) joining. Moreover, it can be seen that, according to a preferred embodiment of the present invention, the indentation and/or protuberance has an essentially rectangular cross section so that, after the separation procedure, surfaces that are parallel to each other or a circumferential flange are formed, which allows a very simple and secure joining of the sheets together.

Preferably, as shown in FIG. 4, the indentation and/or protuberance has an essentially rectangular or U-shaped cross section. The broken lines running perpendicular to the indentation and/or protuberance constitute possible cutting sites. In a preferred embodiment, the circumferential indentation and/or protuberance (4) has essentially the same dimensions around the entire blow molded article. In another embodiment, the indentation and/or protuberance (4) has recesses at the corners of the blow molded article or else the indentation and/or protuberance is markedly shortened at the corners (FIG. 3). According to the invention, the indentation and/or protuberance does not necessarily have to have the same width everywhere. For example, one or more locally widened sections of the indentation and/or protuberance (4) are practical or advantageous if one or more openings are to remain in the hollow plastic articles along the joining seam after the welding or gluing procedure. A widening of the indentation and/or protuberance at a given place makes it impossible for the obtained sheets or cutting surfaces to come into direct contact with each other after the separation, so that an opening remains between the sheets.

Explicit mention is hereby made of the fact that what follows is merely an exemplary description of possible embodiments of the process according to the invention. According to the invention, all embodiments are being claimed that involve the process principle according to the invention.

On the basis of the process according to the invention for the production of hollow plastic articles, first a blow molded article is fabricated in a conventional manner in a regular blow molding or co-extrusion blow molding machine. The principle of the blow molding methods described in the state of the art for shaping plastic consists of taking the plastic in the form of a pipe or tube (parison) that has been melted at a high temperature and extruding it in the middle of an opened mold, subsequently closing the mold and blowing air into the molten plastic. The blown-in air shapes the molten plastic parison against the blowing mold contour, a process in which it acquires the same shape as the mold contour. Upon contact with the inner wall of the mold, the molten plastic—which is, for example, at a temperature or 200° C. [392° F.]—cools off and gradually solidifies. While the plastic is being allowed to solidify, it is common practice to continuously blow in air at a high pressure.

According to tie invention, the blow molding cavity (3) formed by the two mold contours (1) and (2) is shaped in such a way that said cavity essentially matches the outer contour of the plastic hollow article or plastic tank to be manufactured. For instance, mold contour (1) has the shape of the upper half of an automobile fuel tank, while mold contour (2) has the outer contour of the lower half. It is essential to the invention that the above-mentioned blow molding cavity (3) or the blowing mold used for the process according to the invention to additionally have a circumferential indentation and/or protuberance (4), preferably located in the middle relative to the nip-off edge. The above-mentioned circumferential indentation and/or protuberance, however, does not necessarily have to be configured completely uniformly, but rather it can be considerably narrower at the corners of the plastic hollow article or of the blowing mold. In extreme cases, the corners of the plastic tank shown in the first step do not have any indentations and/or protuberances (see FIG. 3).

The plastic parison can be made, for example, in a 6-layer co-extrusion blow molding machine of the kind manufactured and sold by the Krupp Kautex Maschinenbau company. The co-extrusion yields a tubular parison made up of six layers. The layered structure of the parison corresponds to the above-mentioned structure (from the outside to the inside: HDPE, millbase, bonding agent, barrier polymer, bonding agent, HDPE). The layer thickness distribution of the parison likewise falls within the above-mentioned ranges.

If the sheet consists of a single layer made on a blow molding machine, barrier layers can be subsequently applied, for instance, by means of fluorination or painting. These coatings are preferably applied after the half shells have been joined together. However, the coating procedures can also take place before the joining operation, optionally before or after the built-in components have been installed on the half shells.

During co-extrusion, the wall thickness of the parison is adapted to the geometry of the finished article in such way that the most homogeneous wall thickness distribution possible is achieved in the finished article, without any thinned sections. In this context, the wall thickness of the parison is regulated by means of a suitable program that controls the variation with time of the die gap and optionally also by means of radial control of the die gap. The wall thickness distribution is a function of the requirements made of the mechanical behavior of the material as well as, in the case of plastic fuel tanks, the required behavior in case of fire. The diameter or the circumference of the parison tube is adapted to the requirements of the mold and can be easily defined through the appropriate selection of the diameter of the die.

The plastic parison is extruded until the length needed for the mold in question has been reached.

The hollow plastic articles are separated after their removal from the blowing mold, preferably by means of an automated process.

After the blow molded article has been blow molded and separated, built-in components are optionally installed in the half shells. When a plastic fuel tank is being made, for instance, ventilation lines for pressure equalization inside the tank fuel lines for liquid equalization inside the tank, valves, surge chambers, pump modules as well as tank modules for pumping gas, can all be installed in the tank half shells and then welded together with the still melt-hot inner surface. Preferably, robots are employed to perform this task as well. In the last processing step, the two half shells tat are still present in the molds are put together and joined. In this context, the parts of the two sheets that rest on the front face of the mold halves are put in contact with each other and welded together.

1. A process for the production of hollow plastic articles comprising the following steps:
a) molding a blow molded article in a blow molding and/or co-extrusion blow molding machine, whereby the blow molding cavity (3) formed by the two mold contours (1) and (2) is shaped in such a way that said cavity essentially matches the outer contour of the plastic hollow article to be fabricated and, in addition, it has a circumferential indentation and/or protuberance (4), preferably located in the middle relative to the nip-off edge;
b) separation of the indentation and/or protuberance, which yields at least two sheets;
c) optionally, prior to joining the sheets together to form a hollow article, installation of the built-in components on the inside of the sheets;
d) joining the sheets together to form a hollow article, optionally by means of welding or gluing.

2. The process according to claim 1, characterized in that the built-in components are ventilation lines for pressure equalization inside the tank, fuel lines for liquid equalization inside the tank, valves, surge clambers, pump modules and/or tank modules.

3. The process according to one of the preceding claims, characterized in that the indentation and/or protuberance has an essentially rectangular or U-shaped cross section so that, after the separation procedure, surfaces that are parallel to each other (a circumferential flange) are formed in order to join the sheets together.

4. The process according to one of the preceding claims, chacterized in that the blow molded article has at least one layer consisting of polymeric material, preferably selected from among the group comprising polyethylene, polypropylene, polyvinyl chloride, polyamide, polyketone, polyester and/or mixtures thereof.

5. The process according to one of the preceding claims, characterized in that the blow molded article is made up of several layers, preferably containing at least one base layer millbase layer, bonding agent layer and/or barrier layer.

6. The process according to one of the preceding claims, characterized in that the blow molded article is made up of six layers comprising the following from the outside to the inside:
a layer consisting of HDPE having a thickness ranging from 5% to 30%,
a millbase layer having a thickness ranging from 10% to 82%,
a bonding agent layer having a thickness ranging 1% to 5%,
a barrier layer having a thickness ranging from 1% to 10%,
a bonding agent layer having a thickness ranging from 1% to 5%,
a layer consisting of HDPE having a thickness ranging from 10% to 40%,
each relative to the total thickness of the container wall.

7. Hollow plastic articles, which can be produced by means of the process according to claims 1 through 6.

8. A blowing mold to carry out the process according to claims 1 through 6, characterized in that the blow molding cavity (3) formed by the two mold contours (1) and (2) is shaped in such a way that sad cavity essentially matches the outer contour of the plastic hallow article to be manufactured and, in addition, it has a circumferential indentation and/or protuberance (4), preferably located in the middle relative to the nip-off edge.

9. The use of a blow molded hollow article that can be obtained by means of the process according to claims 1 through 6, as plastic fuel tanks in automobiles, also as jerry cans, plastic tanks for storing and transporting heating oil, diesel and solvents, transportation containers on commercial vehicles such as, for instance, for agricultural spraying agents, solvent containers and plastic bottles.
